(19) United States
(12) Patent Application Publication
(10) Pub. No.: US 2009/0152749 A1
(43) Pub. Date: Jun. 18, 2009

(54) METHOD FOR EVAPORATING IR CUT-OFF FIRM UPON A PLASTIC OPTICAL LENS

(76) Inventor: Wen-Hua Lin, Taichung County (TW)

Correspondence Address: Chien-Hui Su, P. O. Box 70-121 Taichung, Taichung City, 40899, TW

(21) Appl. No.: 11/954,239

(22) Filed: Dec. 12, 2007

(51) Int. Cl. B29D 11/00

(52) U.S. Cl. 264/1.36

(57) ABSTRACT

A method for evaporating an IR cut-off firm upon a plastic optical lens with control of ion gun and electronic gun; wherein: retaining a plastic optical lens at a normal temperature without heating; controlling a power of an ion gun to be between 350 W to 850 W in evaporating a film of high refraction coefficient; and a power of an ion gun to be below 500 W in evaporating a film of low refraction coefficient. in evaporating process, the temperature of the plastic optical lens is controlled to be between 80° C.˜150° C. so that no deformation occurs. A plastic optical lens is as a substrate and ion gun and electronic gun use as assistant in evaporation so as to have the effect of evaporating more layers upon the plastic optical lens.

### FIELD OF THE INVENTION

The present invention relates to a method for evaporating an IR (infrared ray) cut-off firm upon a plastic optical lens, in detail, a plastic optical lens is as a substrate and ion gun and electronic gun use as assistant in evaporation so as to have the effect of evaporating more layers upon the plastic optical lens.

### BACKGROUND OF THE INVENTION

In the optical lens, the semiconductor image sensors (such as CCD, CMOS, etc.) are sensitive to infrared rays so as to induce errors in the determination of colors. Most of the lens is coated with an IF ray film so as to increase the reflectivity of the infrared rays. Initially, the film is coated upon a plane glass. Then, with the rapid improvement of the optical lens, the lens is made smaller and smaller. To have a small space, many cameras have no plane glass. The optical film is coated upon the glass lens. However currently, the lens is made of plastics which is worse than glass in temperature tolerance. The temperature range for glass substrate is about 150˜600° C., while when the plastic is heated to be above 150° C., the plastics will deform. Thus it is difficult to coat a film upon a plastic optical lens.

Currently, evaporation is used in the plastic optical lens. Conventional evaporation is performed at low temperature for shaping. However when the number of layers is above 20, the film will deform, destroy, etc. due to crack, deformation, separate from mold, and other reasons. However currently, about 50 to 60 layers are necessary for evaporating upon a plastic optical lens so as to have the same effect as the glass material.

Thus, there is an eager demand for a novel design which can improve the defects in the prior art.

### SUMMARY OF THE INVENTION

Accordingly, the primary object of the present invention is to provide an IR cut-off firm upon a plastic optical lens, in detail, a plastic optical lens is as a substrate and ion gun and electronic gun use as assistant in evaporation so as to have the effect of evaporating more layers upon the plastic optical lens. The deformation and destroy of the firm due to crack, deformation, separate from mold, and other reasons are avoided.

To achieve above objects an IR cut-off firm evaporated upon a plastic optical lens wherein ion gun and electronic gun are used as assistance material. The power of the ion gun and electronic gun is used in control. The present invention relates to the process of substrate selection, firm selection, variable control, power control, environment control, and the end process. The feature will be described herein.

The selection of substrate: A common plastic optical lens is used. The plastic optical lens is formed by general used plastic optic material such as PC (polycarbonate), ZONEX (Cycloolefin-Copolymere), APEL (Ziegler), OKP4 (an optical resin material). Before the plastic optical lens of the substrate is unnecessary to be heated, which is retained in normal temperature.

Selection of film: Using IR cut-off filter as an optical filtering film. That is: visible light passes through an infrared ray reflection film. The optical filtering film is adhered to the substrate by the assistance of ion gun and electronic gun.

Variable control: According to above evaporate process, the variables of the film stack structure are controlled. The structure is:

a(HL)̂1 (HL)̂b c(HL)̂d H 0.6 L,

wherein a, b, c and d are variables with ranges of: 0.1≦a≦0.4, 1≦b≦9, 1.1≦c≦1.4, 4≦d≦9, where H is a high refraction material, and L is a low refraction material. “a” is a first film stack thickness coefficient; “b” is a second film stack thickness coefficient; “c” is a third film stack thickness coefficient; and “d” is a fourth film stack thickness coefficient. In that, in this embodiment, the substrate is PC and the film thickness is:

PC/0.2(HL)̂1 (HL)̂8 1.27(HL)̂8 H 0.6 L/air

where

H: Nb2O5; L is S SiO2, PC is substrate and, AIR is air.

Power control: since hardness of a material is decreased rapidly in a predetermined temperature, which is a call a glass transfer temperature (TG). The temperature is different from different material. With referring to FIG. 2, the glass transfer temperature is corresponding to a corresponding power and is operated under this temperature. If it is necessary to evaporate a high reflection film, the power of the ion gun is controlled between 350 W and 850 W. If it is necessary to evaporate a low reflection film, the power of the ion gun is controlled below 500 W. The temperature is controlled by the power control so as to have a low temperature effect of the present invention. Further, when the power is under 850 W, the increasing ratios of temperature and power are lower. Thus it is necessary to control the power to be below 850 W so as to avoid the effect of high temperature to the plastic optical lens.

Environmental control: When the vacuum evaporate machine is vacuumed to be below 1.0*10⁻⁴ Torr, the evaporate is started, the cooling water for evaporation is controlled to be 19° C.±2° C. In the evaporate process, the temperature of the plastic optical lens is controlled to be between 80° C.˜150° C. to avoid the deformation of the plastic optical lens.

By above mentioned process, the optical filtering film is evaporated upon a common plastic optical lens. Less layers (below 40 layers) of the plastic optic material are sued as an optical filtering film which has the same effect as the glass material. Since too high temperature will deform the film and too low transferred will reduce the reflection coefficient of the film so that the adhesive force is not sufficient. It is easy to separate from a mold or make the mold crack. Thus, in the present invention, a very low temperature control is used and parameters of the ion gun and electronic gun are adjusted to have the effect of temperature control (when the power is under 850 W, the increasing ratios of temperature and power are lower. Thus it is necessary to control the power to be below 850 W). Thus, by the present invention, the optical filtering film can be evaporated upon a plastic optical lens. The cost and time are reduced. Furthermore, the present invention can be widely used in AR (Anti Reflection) and RGB (Red [symbol] Green [symbol] Blue).

The various objects and advantages of the present invention will be more readily understood from the following detailed description when read in conjunction with the appended drawing.

### BRIEF DESCRIPTION OF THE DRAWINGS

FIG. 1 is a schematic view showing the evaporation process for evaporating IR cut-off firm upon a plastic optical lens.

FIG. 2 shows the relation of the power of the ion gun with respect to the substrate temperature.

FIG. 3 shows the curve of the optical spectrum according to the present invention.

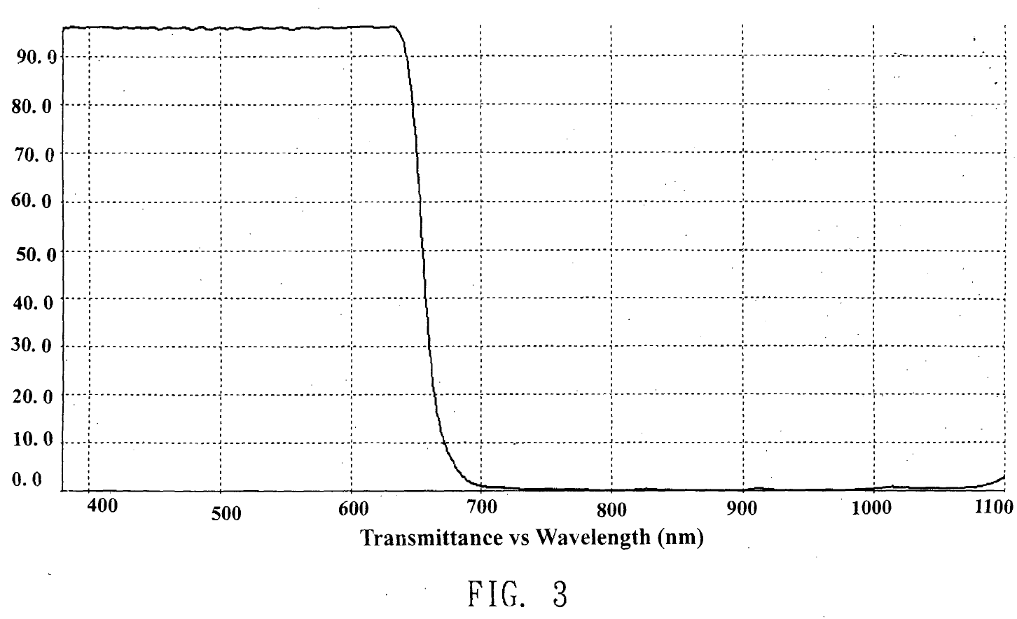

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims. The present invention relates to the process for evaporating an IR cut-off firm upon a plastic optical material.

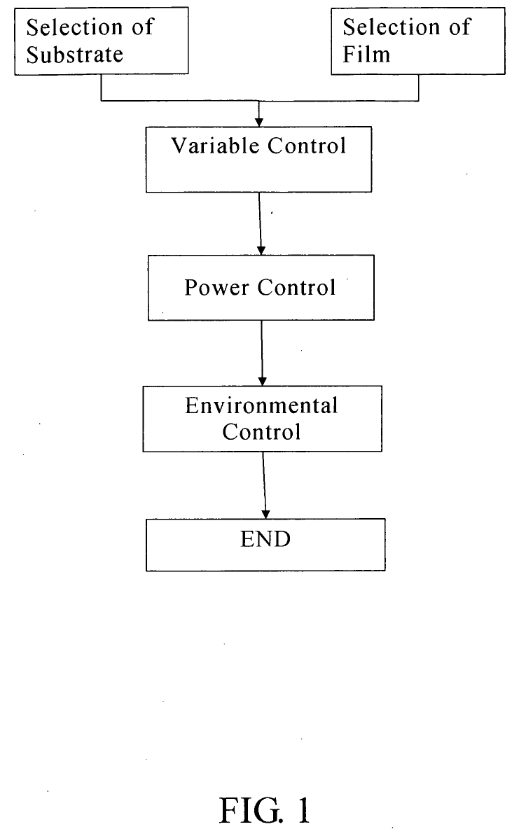

Referring to FIG. 1, the IR cut-off firm is evaporated upon a plastic optical lens wherein ion gun and electronic gun are used as assistance material. The power of the ion gun and electronic gun is used in control. The present invention relates to the process of substrate selection, firm selection, variable control, power control, environment control, and the end process. The feature will be described herein.

The selection of substrate: A common plastic optical lens is used. The plastic optical lens is formed by general used plastic optic material such as PC (polycarbonate), ZONEX (Cycloolefin-Copolymere), APEL (Ziegler), OKP4 (an optical resin material). Before the plastic optical lens of the substrate is unnecessary to be heated, which is retained in normal temperature.

Selection of film: Using IR cut-off filter as an optical filtering film. That is: visible light passes through an infrared ray reflection film. The optical filtering film is adhered to the substrate by the assistance of ion gun and electronic gun.

Variable control: According to above evaporate process, the variables of the film stack structure are controlled. The structure is:

a(HL)̂1 (HL)̂b c(HL)̂d H 0.6 L,

wherein a, b, c and d are variables with ranges of: 0.1≦a≦0.4, 1≦b≦9, 1.1≦c≦1.4, 4≦d≦9, where H is a high refraction material, and L is a low refraction material. “a” is a first film stack thickness coefficient; “b” is a second film stack thickness coefficient; “c” is a third film stack thickness coefficient; and “d” is a fourth film stack thickness coefficient. In that, in this embodiment, the substrate is PC and the film thickness is:

PC/0.2(HL)̂1 (HL)̂8 1.27(HL)̂8 H 0.6 L/air

where

H: Nb2O5; L is S SiO2, PC is substrate and, AIR is air.

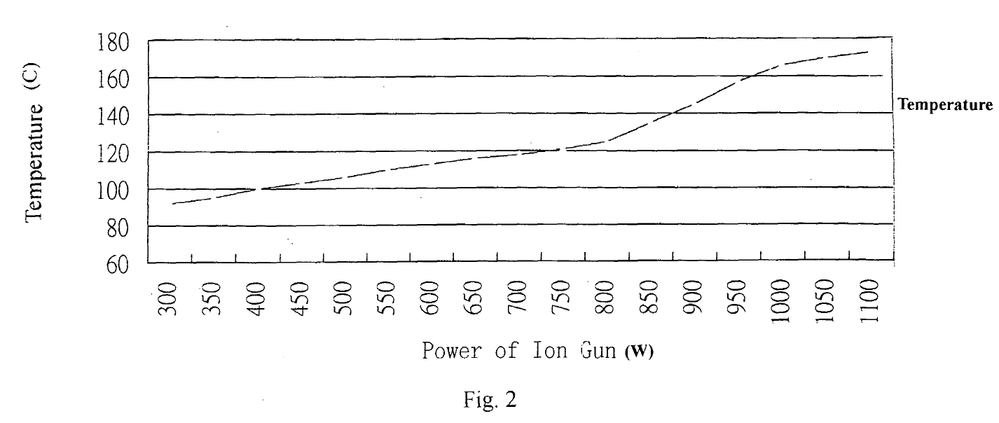

Power control: since hardness of a material is decreased rapidly in a predetermined temperature, which is a call a glass transfer temperature (TG). The temperature is different from different material. With referring to FIG. 2, the glass transfer temperature is corresponding to a corresponding power and is operated under this temperature. If it is necessary to evaporate a high reflection film, the power of the ion gun is controlled between 350 W and 850 W. If it is necessary to evaporate a low reflection film, the power of the ion gun is controlled below 500 W. The temperature is controlled by the power control so as to have a low temperature effect of the present invention. Further, when the power is under 850 W, the increasing ratios of temperature and power are lower. Thus it is necessary to control the power to be below 850 W so as to avoid the effect of high temperature to the plastic optical lens.

Environmental control: When the vacuum evaporate machine is vacuumed to be below 1.0*10⁻⁴ Torr, the evaporate is started, the cooling water for evaporation is controlled to be 19° C.±2° C. In the evaporate process, the temperature of the plastic optical lens is controlled to be between 80° C.˜150° C. to avoid the deformation of the plastic optical lens.

By above mentioned process, the optical filtering film is evaporated upon a common plastic optical lens. Less layers (below 40 layers) of the plastic optic material are sued as an optical filtering film which has the same effect as the glass material. Since too high temperature will deform the film and too low transferred will reduce the reflection coefficient of the film so that the adhesive force is not sufficient. It is easy to separate from a mold or make the mold crack. Thus, in the present invention, a very low temperature control is used and parameters of the ion gun and electronic gun are adjusted to have the effect of temperature control (when the power is under 850 W, the increasing ratios of temperature and power are lower. Thus it is necessary to control the power to be below 850 W). Thus, by the present invention, the optical filtering film can be evaporated upon a plastic optical lens. The cost and time are reduced. Furthermore, the present invention can be widely used in AR (Anti Reflection) and RGB (Red [symbol] Green [symbol] Blue).

In, the present invention, the variables of the film stack structure are controlled. The structure is:

a(HL)̂1 (HL)̂b c(HL)̂d H 0.6 L,

wherein a, b, c and d are variables with ranges of: 0.1≦a≦0.4, 1≦b≦9, 1.1≦c≦1.4, 4≦d≦9, where H is a high refraction material, and L is a low refraction material. “a” is a first film stack thickness coefficient; “b” is a second film stack thickness coefficient; “c” is a third film stack thickness coefficient; and “d” is a fourth film stack thickness coefficient. In that, in this embodiment, the substrate is PC. The way for film stacking is: PC/0.2(HL)̂1 (HL)̂8 1.27(HL)̂8 H 0.6 L/air. The reference optical spectrum is 550 nm. In this the present invention, such as high refraction material, such as TiO₂, Ti₃O₅, Ta₂O₅, ZrO₂, Nb₂O₅, and low refraction material, such as SiO₂ [symbol] Mgf₂.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for evaporating an IR cut-off firm upon a plastic optical lens with control of ion gun and electronic gun; wherein:
retaining a plastic optical lens at a normal temperature without heating;
controlling a power of an ion gun to be between 350 W to 850 W in evaporating a film of high refraction coefficient, and a power of an ion gun to be below 500 W in evaporating a film of low refraction coefficient.

2. The method as claimed in claim 1, wherein in evaporating process, the temperature of the plastic optical lens is controlled to be between 80° C.˜150° C. so that no deformation occurs.

3. The method as claimed in claim 1, wherein a stack of IR cut-off firms is formed with a structure of a (HL)̂1 (HL)̂b c(H L)̂d H 0.6 L,
wherein a, b, c and d are variables with ranges of: 0.1≦a≦0.4, 1≦b≦9, 1.1≦c≦1.4, 4≦d≦9, where H is a high refraction material, and L is a low refraction material, “a” is a first film stack thickness coefficient; “b” is a second film stack thickness coefficient; “c” is a third film stack thickness coefficient; and “d” is a fourth film stack thickness coefficient.
